(19) United States
(12) Patent Application Publication
(10) Pub. No.: US 2026/0291656 A1
(43) Pub. Date: Sep. 24, 2026

(54) USER EQUIPMENT MEASUREMENT RESTRICTIONS TO PROTECT CRITICAL DATA RECEPTIONS

(71) Applicant: Nokia Technologies Oy, Espoo (FI)

(72) Inventors: Claudio ROSA, Aalborg (DK); Klaus Ingemann PEDERSEN, Aalborg (DK); Stefano PARIS, Massy (FR); Zexian LI, Espoo (FI)

(21) Appl. No.: 19/475,545

(22) PCT Filed: Mar. 13, 2024
(86) PCT No.: PCT/EP2024/056652

§ 371 Date: Oct. 15, 2025

Related U.S. Application Data
(60) Provisional application No. 63/460,649, filed on Apr. 20, 2023.

(51) Int. Cl. H04L 1/1829

(52) U.S. Cl. CPC H04L 1/1854

(57) ABSTRACT

In accordance with example embodiments of the invention there is at least a method and apparatus to perform attempting to decode a data transmission of a network node of a communication network; based on the decoding failing, perform: transmitting a negative acknowledgment within a first time window, skipping a second time window for radio resource management measurements to perform transmission of the negative acknowledgment or reception of a grant scheduling a retransmission of said data transmission or reception of a retransmission of said data transmission. Further, to perform sending a data transmission from a network node of a communication network towards a user equipment; based on decoding of the data transmission failing at the user equipment, receiving an indication that the user equipment is to skip a second time window for radio resource management measurements to perform transmission of the negative acknowledgment, reception of a grant scheduling a reception, or retransmission of said data transmission, or reception of a retransmission of said data transmission, wherein the indication can be receiving a negative acknowledgment within a first time window.

### TECHNICAL FIELD

The teachings in accordance with the exemplary embodiments of this invention relate generally to enhancement of data transmission of delay-critical data such as XR and, more specifically, relate to enhancement of data transmission of delay-critical data such as XR without being compromised by scheduling restrictions from the UE as prioritizing RRM measurements over data reception/transmission.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
CA Carrier Aggregation
DC Dual Connectivity
MUSIM Multi Universal Subscriber Identity Module
NTWK Network
PS Packet Switched
RACH Random Access Channel
RRC Radio Resource Control
Rx Receiver
TDM Time Division Multiplexing
Tx Transmitter
UAI Assistance Information
UE User Equipment
USIM Universal Subscriber Identity Module

Network-centric solutions relying on the gNB to inform the UE to skip a certain pattern of SMTC windows for RRM measurements and instead prioritize PDCCH/PDSCH reception and PUSCH/PUCCH transmission have been proposed. In addition, there has been proposed a resource allocation pattern based approach to handle data transmission and measurement gap.

However, there are problem of harmful scheduling restrictions due to RRM measurements.

Example embodiments of this invention proposes improvements for at least these operations.

### SUMMARY

This section contains examples of possible implementations and is not meant to be limiting.

In an example aspect of the invention, there is an apparatus, such as a user equipment side apparatus, comprising: at least one processor; and at least one non-transitory memory storing instructions, that when executed by the at least one processor, cause the apparatus at least to: attempt to decode a data transmission of a network node of a communication network; based on the decoding failing, based on the decoding failing, perform: transmitting a negative acknowledgment within a first time window, skipping a second time window for radio resource management measurements to perform transmission of the negative acknowledgment or reception of a grant scheduling a retransmission of said data transmission or reception of a retransmission of said data transmission.

In still another example aspect of the invention, there is a method, comprising: attempting to decode a data transmission of a network node of a communication network; based on the decoding failing, based on the decoding failing, perform: transmitting a negative acknowledgment within a first time window, skipping a second time window for radio resource management measurements to perform transmission of the negative acknowledgment or reception of a grant scheduling a retransmission of said data transmission or reception of a retransmission of said data transmission.

A further example embodiment is an apparatus and a method comprising the apparatus and the method of the previous paragraphs, wherein the first time window and the second time window is one of overlapping or the first time window comprises the second time window, wherein the second time window comprises a measurement gap or a synchronization signal block based measurement timing configuration, wherein there is sending towards the network node of the communication network information comprising an indication that the second time window comprising a measurement gap or a synchronization signal block based measurement timing configuration is to be skipped for radio resource management measurements, wherein the indication that the second time window is to be skipped is one of multiplexed with a hybrid automatic repeat request negative acknowledgement or sent as a standalone indication, wherein the indication that the second time window is to be skipped for radio resource management measurements comprises a transmission of a hybrid automatic repeat request negative acknowledgement within a first time window, wherein the skipping is based on a mobility state and a scaling factor used for radio resource measurement relaxation, wherein the indication is using a single bit, wherein the indication comprises a physical uplink shared channel transmission or a physical uplink control channel transmission, wherein there is skipping measurements in a measurement gap or synchronization signal block based measurement timing configuration to prioritize transmission of the negative acknowledgement, wherein there is receiving a configuration indicating to skip radio resource management measurements in the second time window in order to transmit a negative acknowledgement within the first time window or the second time window, or receiving a retransmission of the data transmission from the network node to the user equipment within the second time window, wherein the data transmission comprises a hybrid automatic repeat request re-transmission, wherein an indication of the at least one time window is received in the information from the network node using radio resource control signalling, wherein the data transmission comprises a physical downlink shared channel transmission or physical downlink control channel transmission, wherein the decoding failing is determined using a cyclic redundancy check, wherein the configuration comprises the start of the first time window with respect to the second time window, wherein the configuration comprises a number of occurrences of the second time window in which radio resource management measurements are to be skipped, and whether to use implicit or explicit indication for skipping the time window, wherein the configuration comprises a radio resource control configuration, and/or wherein skipping the second time window for radio resource management measurements is based on a priority of an uplink negative acknowledgement, a downlink transmission or re-transmission grant from the communication network, a downlink data transmission or re-transmission from the communication network, or an uplink acknowledgement or negative acknowledgement from user equipment.

A non-transitory computer-readable medium storing program code, the program code executed by at least one processor to perform at least the method as described in the paragraphs above.

In yet another example aspect of the invention, there is an apparatus comprising: means for attempting to decode a data transmission of a network node of a communication network; means, based on the decoding failing, for performing: transmitting a negative acknowledgment within a first time window, skipping a second time window for radio resource management measurements to perform transmission of the negative acknowledgment or reception of a grant scheduling a retransmission of said data transmission or reception of a retransmission of said data transmission.

In accordance with the example embodiments as described in the paragraph above, at least the means for attempting, using, and prioritizing comprises a network interface, and computer program code stored on a computer-readable medium and executed by at least one processor.

In another example aspect of the invention, there is an apparatus, such as a network side apparatus, comprising: at least one processor; and at least one non-transitory memory storing instructions, that when executed by the at least one processor, cause the apparatus at least to: send a data transmission from a network node of a communication network towards a user equipment; based on decoding of the data transmission failing at the user equipment, receive an indication that the user equipment is to skip a second time window for radio resource management measurements to perform transmission of the negative acknowledgment, reception of a grant scheduling a reception, or retransmission of said data transmission, or reception of a retransmission of said data transmission, wherein the indication can be receiving a negative acknowledgment within a first time window.

In still another example aspect of the invention, there is a method, comprising: sending a data transmission from a network node of a communication network towards a user equipment; based on decoding of the data transmission failing at the user equipment, receive an indication that the user equipment is to skip a second time window for radio resource management measurements to perform transmission of the negative acknowledgment, reception of a grant scheduling a reception, or retransmission of said data transmission, or reception of a retransmission of said data transmission, wherein the indication can be receiving a negative acknowledgment within a first time window.

A further example embodiment is an apparatus and a method comprising the apparatus and the method of the previous paragraphs, wherein the first time window and the second time window is one of overlapping or the first time window comprises the second time window, wherein the second time window comprises a measurement gap or a synchronization signal block based measurement timing configuration, wherein the indication is that the second time window comprising a synchronization signal block based measurement timing configuration window is to be skipped for radio resource management measurements, wherein the indication that the second time window is to be skipped is one of multiplexed with a hybrid automatic repeat request negative acknowledgement or sent as a standalone indication, and wherein the indication that the second time window is to be skipped for radio resource management measurements comprises a reception of a hybrid automatic repeat request negative acknowledgement within a first time window, wherein the skipping is based on a mobility state and a scaling factor used for radio resource measurement relaxation, wherein the indication is using a single bit, wherein the indication comprises a physical uplink shared channel transmission or a physical uplink control channel transmission, wherein the indication is that the user equipment will skip measurements in a measurement gap or synchronization signal block based measurement timing configuration to prioritize transmission of the negative acknowledgement, wherein there is sending a configuration indicating to the user equipment to skip radio resource management measurements in the second time window in order to transmit or receive a negative acknowledgement from the user equipment within the first time window or the second time window, or sending a retransmission of the data transmission from the network node to the user equipment within the second time window, wherein the data transmission comprises a hybrid automatic repeat request re-transmission, wherein the data transmission comprises a physical downlink shared channel transmission or physical downlink control channel transmission, wherein the configuration comprises a start of the first time window with respect to the second time window, and/or wherein the configuration comprises a number of occurrences of the second time window in which radio resource management measurements are to be skipped, and whether to use implicit or explicit indication for skipping the time window.

A non-transitory computer-readable medium storing program code, the program code executed by at least one processor to perform at least the method as described in the paragraphs above.

In yet another example aspect of the invention, there is an apparatus comprising: means for sending a data transmission from a network node of a communication network towards user equipment; means for sending a data transmission from a network node of a communication network towards a user equipment; means, based on decoding of the data transmission failing at the user equipment, for receiving an indication that the user equipment is to skip a second time window for radio resource management measurements to perform transmission of the negative acknowledgment, means for reception of a grant scheduling a reception, or retransmission of said data transmission, or means for reception of a retransmission of said data transmission, wherein the indication can be receiving a negative acknowledgment within a first time window.

In accordance with the example embodiments as described in the paragraph above, at least the means for sending and receiving comprises a network interface, and computer program code stored on a computer-readable medium and executed by at least one processor.

A communication system comprising the network side apparatus and the user equipment side apparatus performing operations as described above.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows a packet successfully delivered beyond the PDB due to the MG/SMTC window;

FIG. 2 shows a Signal diagram in accordance with example embodiments of the invention;

FIG. 3 shows a packet successfully delivered within the PDB in accordance with example embodiments of the invention;

FIG. 4 shows a high level block diagram of various devices used in carrying out various aspects of the invention; and

FIG. 5A and FIG. 5B each show a method in accordance with example embodiments of the invention which may be performed by an apparatus.

### DETAILED DESCRIPTION

In example embodiments of this invention there is proposed at least a method and apparatus for enhancement of data transmission of delay-critical data such as XR without being compromised by scheduling restrictions from the UE as prioritizing RRM measurements over data reception/transmission.

Example embodiments of the invention relate to general enhancement of data transmission of delay-critical data such as XR without being compromised by scheduling restrictions from the UE as prioritizing RRM measurements over data reception/transmission. The invention relates to 3GPP NR standardization and is particularly relevant for XR use cases.

The problem of harmful scheduling restrictions due to RRM measurements and network-centric solutions were discussed in standards meetings at the time of this application. In short, these network-centric solutions were relying on the gNB to inform the UE to skip a certain pattern of SMTC windows for RRM measurements and instead prioritize PDCCH/PDSCH reception and PUSCH/PUCCH transmission. There was proposed a resource allocation pattern based approach to handle data transmission and measurement gap. However, in example embodiments of the invention there is proposed an alternative UE autonomous method to skip certain SMTC windows for intra-frequency measurements, or measurement gaps (MGs) for inter-frequency RRM measurements, to prioritize reception of HARQ Re-Transmissions (ReTx).

The example embodiments of the invention as disclosed herein are standards relevant for 5G-Advanced in 3GPP. As was found in standards at the time of this application, overcoming the problems of scheduling restrictions from RRM measurements is important to avoid XR capacity losses.

According to the 3GPP NR specifications at the time of this application, the network configures the UE when to measure RSRP from e.g., SSBs. This is configured by means of RRC signalling of the so-called SMTC (SSB measurement timing configuration), see extract from the relevant references to 3GPP below. It should be noted that the SMTC only instruct the UE when (in time domain) it could/should measure RSRP, while it is left completely open for UE implementation exactly when to measure, and which antenna panel to be used for conducting such measurement during those “SMTC measurement windows” (if the UE has multiple antenna panels).

Reference is made to 3GPP TS 38.331:5.5.2.10 Reference signal measurement timing configuration.

Here, the UE shall setup the first SS/PBCH block measurement timing configuration (SMTC) in accordance with the received periodicityAndOffset parameter (providing Periodicity and Offset value for the following condition) in the smtc1 configuration. The first subframe of each SMTC occasion occurs at an SFN and subframe of the NR SpCell meeting the following condition:

$$SFN mod T = ( FLOOR ( Offset / 10 ) ) ;$$

if the Periodicity is larger than sf5:

$$subframe = Offset mod 10 ;$$

else:

$$subframe = Offset or ( Offset + 5 ) ;$$

with T=CEIL (Periodicity/10).
   If smtc2 is present, for cells indicated in the pci-List parameter in smtc2 in the same MeasObjectNR, the UE shall setup an additional SS/PBCH block measurement timing configuration (SMTC) [ . . . ].
   If smtc3list is present, for cells indicated in the pci-List parameter in each SSB-MTC3 element of the list in the same MeasObjectNR, the IAB-MT shall setup an additional SS block measurement timing configuration [ . . . ].

On the indicated ssbFrequency, in accordance with standards at the time of this application the UE shall not consider SS/PBCH block transmission in subframes outside the SMTC occasion for RRM measurements based on SS/PBCH blocks and for RRM measurements based on CSI-RS except for SFTD measurement.

The corresponding UE requirements for RRM measurements are specified in 3GPP TS 38.133. This specification also lists related scheduling restrictions for UEs during time-intervals where they may be performing RSRP or RSRQ measurements as per the SMTC configuration. It is noted that any reference to RSRP or L1-RSRP type measurement herein may instead or in addition to be referencing an RSRQ type measurement. The relevant text on such scheduling restrictions from that specification is repeated in the below text box. What is interesting to note here is that there are no scheduling restrictions for FR1 (i.e., for UEs on 400 MHz-7 GHz bands), while there are some scheduling restrictions for FR2 (24-52 GHz bands) operation if RSRP is measured on SSBs. It should also be noted this text relates to intra-frequency measurements. In case of inter-frequency measurements, measurement gaps (MGs) may be needed when operating on either FR1 or FR2.

Reference is made to standards on Scheduling availability of UE performing L1-RSRP measurement with same subcarrier spacing as PDSCH/PDCCH on FR1.

Here, there are no scheduling restrictions due to L1-RSRP measurement performed on SSB and CSI-RS configured as RS for L1-RSRP measurement with the same SCS as PDSCH/PDCCH in FR1.

Reference is made to standards on Scheduling availability of UE performing L1-RSRP measurement on FR2.

Here, the scheduling availability requirements in this clause are not applicable if any of the following conditions are met:
The scheduling availability requirements in this clause are not applicable if any of the following conditions are met:
   The network configures simultaneous UL/DL between two FR2 bands if the UE does not have the capability of supporting simultaneousRxTxInterBandCA;
   The network configures mixed numerology on two FR2 CCs if the UE does not have the capability of supporting simultaneous reception with two different numerologies between FR2 CCs in DL;
   The network configures mixed numerology between SSB and data on two FR2 bands if the UE does not have the capability of simultaneousRxDataSSB-DiffNumerology in FR2.

The following scheduling restriction applies due to L1-RSRP measurement:
For the case where RS for L1-RSRP measurement is CSI-RS which is QCLed with active TCI state for PDCCH/PDSCH and not in a CSI-RS resource set with repetition ON, and N=1 applies;
   There are no scheduling restrictions due to L1-RSRP measurement performed based on the CSI-RS;
Otherwise:
   The UE is not expected to transmit PUCCH/PUSCH/SRS or receive PDCCH/PDSCH/CSI-RS for tracking/CSI-RS for CQI on:
      symbols corresponding to the SSB indexes configured for L1-RSRP measurement, and/or
      symbols corresponding to the periodic CSI-RS resource configured for L1-RSRP measurement, and/or
      symbols corresponding to the semi-persistent CSI-RS resource configured for L1-RSRP measurement when the resource is activated, and/or
      symbols corresponding to the aperiodic CSI-RS resource configured for L1-RSRP measurement when the reporting is triggered.

From standards at the time of this application it can be seen that the primary XR real-time video traffic model generates new frames (payloads) at 60 fps, so arriving every 16.6 ms on average. According to 3GPP definitions, 99% of those frames must be successfully delivered to the receiving end (UE in our case) within a certain packet delay budget (PDB), which typically is on the order of 10-15 ms. If operating with standard MG/SMTC settings of performing RRM measurements every 20 ms, with an MG/SMTC window of 5 ms, significant loss of XR system capacity is expected as also captured in 3GPP TR 38.835. In particular, the number of satisfied XR UEs (i.e., UEs with fulfilled QoS criteria) may drop by up to 50% when scheduling restrictions are applied due to RRM measurements.

This XR capacity drop is due to several causes: it may e.g., happen that a gNB schedules a new DL transmission with XR shortly before a MG/SMTC window is starting. If that happens, scheduling a potential HARQ ReTx will have to be postponed until after the MG/SMTC window, which results in unacceptable latencies that will in many cases violate the PDB constraint.

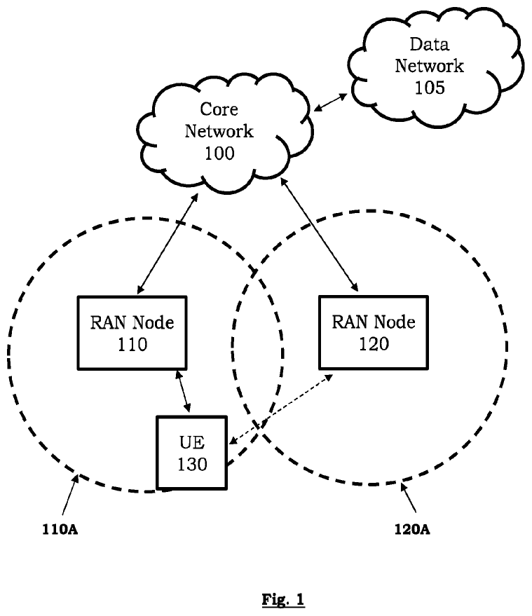

FIG. 1 shows a packet successfully delivered beyond the PDB due to the MG/SMTC window that makes the UE unavailable for 5 ms.

FIG. 1 illustrates this problem: the 3^{rd} transmission attempt is executed beyond the PDB (e.g., 10 ms). Similarly, it may happen that a UE will have to postpone its HARQ ACK/NACK transmission until after a MG/SMTC window (typically taking values of 5 ms), which also results in unacceptable latencies for XR applications (and other delay-critical applications). Note also that depending on UE processing capability and the system configuration, the transmission of the HARQ NACK in the second attempt may be postponed due to the UE processing time to prepare UL transmission. Hence, example embodiments of the invention at least address the problem of avoiding latencies for downlink HARQ operation due to restrictions caused by MG/SMTC windows where the UE instead prioritizes RRM measurements (intra- or inter-frequency). One aim of the example embodiments of the invention is to provide UE autonomous solutions for this problem.

As similarly stated above, network-centric solutions relying on the gNB to inform the UE to skip a certain pattern of SMTC windows for RRM measurements and instead prioritize PDCCH/PDSCH reception and PUSCH/PUCCH transmission have been proposed. In addition, there has been proposed a resource allocation pattern based approach to handle data transmission and measurement gap. Notice that those quoted solutions are all network centric, while what in accordance with example embodiments of the invention there is proposed a UE autonomous method that relies on other novel mechanisms.

The current UE requirements for RRM measurements are specified in 3GPP TS 38.133, where scheduling restrictions due to RRM measurements is also specified.

Example embodiments of the invention at least work to provide enhancement of data transmission of delay-critical data such as XR.

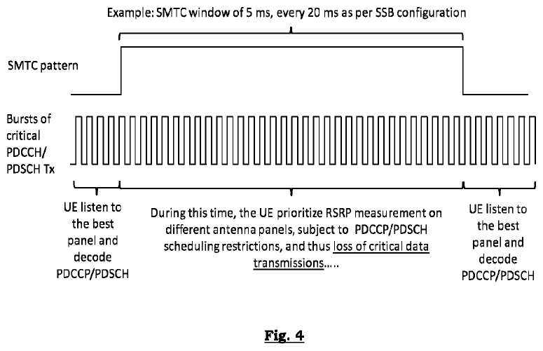

Before describing the example embodiments as disclosed herein in detail, reference is made to FIG. 4 for illustrating a simplified block diagram of various electronic devices that are suitable for use in practicing the example embodiments of this invention.

FIG. 4 shows a block diagram of one possible and non-limiting exemplary system in which the example embodiments may be practiced. In FIG. 4, a user equipment (UE) 10 is in wireless communication with a wireless network 1 or network, 1 as in FIG. 4. The wireless network 1 or network 1 as in FIG. 4 can comprise a communication network such as a mobile network e.g., the mobile network 1 or first mobile network as disclosed herein. Any reference herein to a wireless network 1 as in FIG. 4 can be seen as a reference to any wireless network as disclosed herein. Further, the wireless network 1 as in FIG. 4 can also comprise hardwired features as may be required by a communication network. A UE is a wireless, typically mobile device that can access a wireless network. The UE, for example, may be a mobile phone (or called a “cellular” phone) and/or a computer with a mobile terminal function. For example, the UE or mobile terminal may also be a portable, pocket, handheld, computer-embedded or vehicle-mounted mobile device and performs a language signaling and/or data exchange with the RAN.

The UE 10 includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which can be optionally connected to one or more antennas for communication to NN 12 and NN 13, respectively. The one or more memories MEM 10B include computer program code PROG 10C. The UE 10 communicates with NN 12 and/or NN 13 via a wireless link 11 or 16.

The NN 12 (NR/5G Node B, an evolved NB, or LTE device) is a network node such as a master or secondary node base station (e.g., for NR or LTE long term evolution) that communicates with devices such as NN 13 and UE 10 of FIG. 4. The NN 12 provides access to wireless devices such as the UE 10 to the wireless network 1. The NN 12 includes one or more processors DP 12A, one or more memories MEM 12B, and one or more transceivers TRANS 12D interconnected through one or more buses. In accordance with the example embodiments these TRANS 12D can include X2 and/or Xn interfaces for use to perform the example embodiments. Each of the one or more transceivers TRANS 12D includes a receiver and a transmitter. The one or more transceivers TRANS 12D can be optionally connected to one or more antennas for communication over at least link 11 with the UE 10. The one or more memories MEM 12B and the computer program code PROG 12C are configured to cause, with the one or more processors DP 12A, the NN 12 to perform one or more of the operations as described herein. The NN 12 may communicate with another gNB or eNB, or a device such as the NN 13 such as via link 16. Further, the link 11, link 16 and/or any other link may be wired or wireless or both and may implement, e.g., an X2 or Xn interface. Further the link 11 and/or link 16 may be through other network devices such as, but not limited to an NCE/MME/SGW/UDM/PCF/AMF/SMF/LMF 14 device as in FIG. 4. The NN 12 may perform functionalities of an MME (Mobility Management Entity) or SGW (Serving Gateway), such as a User Plane Functionality, and/or an Access Management functionality for LTE and similar functionality for 5G.

The NN 13 can be for WiFi or Bluetooth or other wireless device associated with a mobility function device such as an AMF or SMF, further the NN 13 may comprise a NR/5G Node B or possibly an evolved NB a base station such as a master or secondary node base station (e.g., for NR or LTE long term evolution) that communicates with devices such as the NN 12 and/or UE 10 and/or the wireless network 1. The NN 13 includes one or more processors DP 13A, one or more memories MEM 13B, one or more network interfaces, and one or more transceivers TRANS 13D interconnected through one or more buses. In accordance with the example embodiments these network interfaces of NN 13 can include X2 and/or Xn interfaces for use to perform the example embodiments. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the NN 13 to perform one or more of the operations as described herein. The NN 13 may communicate with another mobility function device and/or eNB such as the NN 12 and the UE 10 or any other device using, e.g., link 11 or link 16 or another link. The Link 16 as shown in FIG. 4 can be used for communication with the NN 12. These links may be wired or wireless or both and may implement, e.g., an X2 or Xn interface. Further, as stated above the link 11 and/or link 16 may be through other network devices such as, but not limited to an NCE/MME/SGW device such as the NCE/MME/SGW/UDM/PCF/AMF/SMF/LMF 14 of FIG. 4.

The one or more buses of the device of FIG. 4 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D and/or TRANS 10D may be implemented as a remote radio head (RRH), with the other elements of the NN 12 being physically in a different location from the RRH, and these devices can include one or more buses that could be implemented in part as fiber optic cable to connect the other elements of the NN 12 to a RRH.

It is noted that although FIG. 4 shows a network node such as NN 12 and NN 13, any of these nodes may can incorporate or be incorporated into an eNodeB or eNB or gNB such as for LTE and NR and would still be configurable to perform example embodiments.

Also, it is noted that description herein indicates that “cells” perform functions, but it should be clear that the gNB that forms the cell and/or a user equipment and/or mobility management function device will perform the functions. In addition, the cell makes up part of a gNB, and there can be multiple cells per gNB.

The wireless network 1 or any network it can represent may or may not include a NCE/MME/SGW/UDM/PCF/AMF/SMF/LMF 14 that may include (NCE) network control element functionality, MME (Mobility Management Entity)/SGW (Serving Gateway) functionality, and/or serving gateway (SGW), and/or MME (Mobility Management Entity) and/or SGW (Serving Gateway) functionality, and/or user data management functionality (UDM), and/or PCF (Policy Control) functionality, and/or Access and Mobility Management Function (AMF) functionality, and/or Session Management (SMF) functionality, and/or Location Management Function (LMF), and/or Authentication Server (AUSF) functionality and which provides connectivity with a further network, such as a telephone network and/or a data communications network (e.g., the Internet), and which is configured to perform any 5G and/or NR operations in addition to or instead of other standard operations at the time of this application. The NCE/MME/SGW/UDM/PCF/AMF/SMF/LMF 14 is configurable to perform operations in accordance with example embodiments in any of an LTE, NR, 5G and/or any standards-based communication technologies being performed or discussed at the time of this application. In addition, it is noted that the operations in accordance with example embodiments, as performed by the NN 12 and/or NN 13, may also be performed at the NCE/MME/SGW/UDM/PCF/AMF/SMF/LMF 14.

The NCE/MME/SGW/UDM/PCF/AMF/SMF/LMF 14 includes one or more processors DP 14A, one or more memories MEM 14B, and one or more network interfaces (N/W I/F(s)), interconnected through one or more buses coupled with the link 13 and/or link 16. In accordance with the example embodiments these network interfaces can include X2 and/or Xn interfaces for use to perform the example embodiments. The one or more memories MEM 14B include computer program code PROG 14C. The one or more memories MEM 14B and the computer program code PROG 14C are configured to, with the one or more processors DP 14A, cause the NCE/MME/SGW/UDM/PCF/AMF/SMF/LMF 14 to perform one or more operations which may be needed to support the operations in accordance with the example embodiments.

It is noted that that the NN 12 and/or NN 13 and/or UE 10 can be configured (e.g., based on standards implementations etc.) to perform functionality of a Location Management Function (LMF). The LMF functionality may be embodied in any of these network devices or other devices associated with these devices. In addition, an LMF such as the LMF of the MME/SGW/UDM/PCF/AMF/SMF/LMF 14 of FIG. 4, as at least described below, can be co-located with UE 10 such as to be separate from the NN 12 and/or NN 13 of FIG. 4 for performing operations in accordance with example embodiments as disclosed herein.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP10, DP12A, DP13A, and/or DP14A and memories MEM 10B, MEM 12B, MEM 13B, and/or MEM 14B, and also such virtualized entities create technical effects.

The computer readable memories MEM 12B, MEM 13B, and MEM 14B may be of any type suitable to the local technical environment and may be implemented using any suitable data storage technology, such as semiconductor-based memory devices, flash memory, magnetic memory devices and systems, optical memory devices and systems, fixed memory and removable memory. The computer readable memories MEM 12B, MEM 13B, and MEM 14B may be means for performing storage functions. The processors DP10, DP12A, DP13A, and DP14A may be of any type suitable to the local technical environment, and may include one or more of general purpose computers, special purpose computers, microprocessors, digital signal processors (DSPs) and processors based on a multi-core processor architecture, as non-limiting examples. The processors DP10, DP12A, DP13A, and DP14A may be means for performing functions, such as controlling the UE 10, NN 12, NN 13, and other functions as described herein.

In general, various embodiments of any of these devices can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Further, the various embodiments of any of these devices can be used with a UE vehicle, a High Altitude Platform Station, or any other such type node associated with a terrestrial network or any drone type radio or a radio in aircraft or other airborne vehicle or a vessel that travels on water such as a boat.

One idea in accordance with example embodiments of the invention can be summarized as follows:

As the initial step to enable the proposed procedure, the network such as the Network 1 or gNB of the network configures the rule to the UE, e.g. in case HARQ NACK is sent shortly before the start of a MG/SMTC window, DL reception is prioritized over RRM measurements. In addition, the gNB can configure that such a rule is only applicable to the PDSCH with high PHY priority. After this, the following steps are performed:
A. The gNB schedules a downlink data transmission on the PDSCH;
B. UE attempts decoding of the PDSCH transmissions and determines if the PDSCH transmission was correctly decoded based on e.g., the CRC check. If the UE successfully decodes the transmission, it will prepare transmission of HARQ ACK, and otherwise HARQ NACK;
C. If the UE sends HARQ NACK shortly before the start of a MG/SMTC window
   both UE and gNB assume that the MG/SMTC is skipped such that the UE will prioritize decoding HARQ retransmission (ReTx) that the gNB is expected to schedule immediately upon the reception of the HARQ NACK;
      Else if UE send HARQ ACK:
   UE follows the standard procedure when entering the MG/SMTC window to prioritize RRM measurements over PDCCH/PDSCH decoding as per current NR 3GPP specifications.

Step C is one key inventive step in accordance with example embodiments of the invention.

In an embodiment HARQ retransmission (ReTx) may include the transmission of a scheduling grant on the physical downlink control channel (PDCCH) and the retransmission of the data on the physical downlink shared channel (PDSCH).

In another embodiment, if the UE attempts PDSCH decoding, and then enters a MG/SMTC window before it sends the ACK/NACK in the uplink, the UE shall skip or escape the MG/SMTC window at its earliest opportunity to send the ACK/NACK feedback only in case of NACK (i.e., unsuccessful reception). As per the procedure outlined above in Step C, the UE shall remain “out-of-the-MG/SMTC window”, i.e. skip or escape the entire MG/SMTC window.

It is noted that in accordance with example embodiments of the invention the UE can be configured to skip or escape from the MG/SMTC window, and in accordance with example embodiments of the invention the network can provide a configuration as disclosed herein to cause the UE to perform the skipping or escaping.

Notice that the proposed solution is UE autonomous in the sense that MG/SMTC windows are skipped in an autonomous manner by the UE based on network configuration, depending on its downlink decoding performance, and hence avoids unnecessary delays for HARQ retransmissions. This is very important for XR use cases (and other applications with strict latency requirements) as delaying a HARQ retransmission by 5 ms due to a MG/SMTC window of that duration would violate the PDB constraint for most cases.

It is worth to point out the proposed scheme is equally applicable to the cases where the first DL data transmission is either a dynamically scheduled DL transmission (i.e. PDSCH transmission scheduled by DCI command transmitted on the PDCCH) or a DL semi-persistent scheduling (SPS) based PDSCH transmission.

It can be assumed that the network is in charge of deciding it and a certain UE shall operate with the proposed invention. Hence, for UEs where the network wants to enable using the disclosed invention, we propose that the gNB signals the UE to use it. This could be realized by using e.g., RRC signaling from the gNB to the UE to enable using the proposed invention. Such RRC signaling may also include parameters for what “ . . . shortly before the start of a MG/SMTC window . . . ” means as expressed in Step C of the invention. Here “shortly before” could simply be expressed in units of OFDMA symbols, such that the condition would read “ . . . . X symbols, slots, or subframes before the start of a MG/SMTC window”, where the value of X is part of the RRC configuration of the UE to use the invention. The value of X must be selected taking into account the gNB and UE processing capabilities, which are all known at the gNB-side, given the UEs processing capabilities as already standardized by 3GPP in 3GPP TS 38.214. In another possible implementation, the value of X may be fixed in specifications.

The actual UE behaviour as expressed in Step C (repeat here for the sake of easy referencing):
C: If the UE sends HARQ NACK shortly before the start of a MG/SMTC window (i.e., less than or equal to X symbols, slots, or subframes before the start of the MG/SMTC window):
   both UE and gNB assume that the MG/SMTC is skipped such that the UE will prioritize decoding HARQ ReTx that the gNB is expected to schedule immediately upon reception of the NACK;
else if UE sends ACK:
   UE follows the standard procedure when entering the MG/SMTC window to prioritize RRM measurements over PDCCH/PDSCH decoding as per current NR 3GPP specifications.

Such UE behavior shall be captured in the 3GPP NR specifications. It would likely need to be captured in the PHY/MAC specifications, as well as the UE requirements/behavior specifications such as 3GPP TS 38.133.

In a second embodiment in accordance with example embodiments of the invention, the UE sends an explicit indication (i.e., in another form than NACK) to the network that it will skip the next MG/SMTC window(s). In an implementation of this embodiment, the indication is represented as a single bit to indicate the intention to skip the next MG/SMTC window. In other implementations, the indication can be implemented as a number of MG/SMTC windows that are skipped. In an additional implementation, the indication is represented as a single bit and the number of MG/SMTC windows that are skipped is configured using RRC signaling.

In a third embodiment in accordance with example embodiments of the invention: if the UE attempts PDSCH decoding, and then enters a MG/SMTC window before it sends the ACK/NACK in the uplink, the UE shall skip or escape the MG/SMTC window at its earliest opportunity to send the ACK/NACK feedback only in case of NACK (i.e. unsuccessful reception). As per the procedure outlined above in Step C, the UE shall remain “out-of-the-MG/SMTC window”, i.e. skip or escape the entire MG/SMTC window.

In all embodiments with explicit indication by the UE of skipping the next MG/SMTC window(s) (either multiplexed in HARQ NACK or as stand-alone indication), the skipping decision can be based also on the UE mobility state and scaling factor used for RRM measurement relaxation. For example, when either Medium- or High-mobility state is detected, the UE can decide not to skip the next MG/SMTC window(s). Whether the UE is allowed to autonomously determine whether or not to skip the next MG/SMTC window(s) based on mobility state, could also be based on network configuration. The intention to either skip or maintain the next MG/SMTC window(s) is indicated to the network using for example a single bit (e.g., 0: to indicate that the next MG/SMTC window is not skipped). Alternatively, the UE only indicates the intention to skip the next MG/SMTC window(s). If the UE does not send an explicit indication, the UE and gNB assume the UE prioritizes RRM measurements over PDCCH/PDSCH decoding as per current NR 3GPP specifications.

In one example embodiment, the single bit information can be carried over PHY signalling for example via different DMRS sequences, different scrambling codes and so on. Or as another alternative embodiment, the single bit can be part of UL control information (UCI).

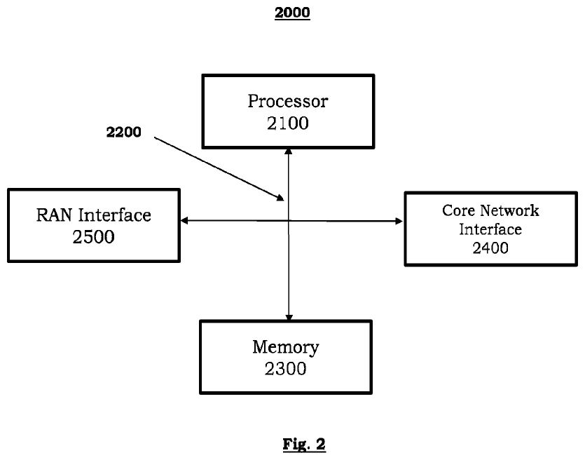

FIG. 2 shows a signaling diagram in accordance with example embodiments of the invention: according to the behavior agreed between network and UE, the MG/SMTC window is skipped after the first UL transmission. Depending on the implementation, the skip indication can be explicitly transmitted or implicitly inferred by NW and UE if the time between the UL transmission and the next MG/SMTC window is smaller than a threshold.

In FIG. 2 there is shown an example of a signaling flow diagram for the invention.

FIG. 2 shows operations with a Network (NW) 1 and a UE 10 as shown in FIG. 4. As shown in step 205 of FIG. 2 the NW 1 and the UE 10 agree upon behavior and configuration to skip MG/SMTC window and its scheduling restrictions. As shown in step 210 of FIG. 2 the NW 1 sends towards the UE 10 a 1^{st} DL data transmission attempt. As shown in step 212 of FIG. 2 the UE 10 identifies a CRC error. As shown in step 215 of FIG. 2 the UE 10 sends towards the NW 1 a UL transmission of HARQ NACK and an optional explicit indication to skip MG/SMTC window. As shown in step 217 of FIG. 2 the NW 1 identifies that the UE 10 is available for scheduling. As shown in step 218 of FIG. 2 the UE 10 identifies to skip the MG/SMTC window. As shown in step 220 of FIG. 2 the NW 1 sends towards the UE 10 a 2^{nd} DL data transmission attempt (1^{st} reTx). As shown in step 222 of FIG. 2 the UE detects a transmission error (e.g., with CRC error 222) of the 1^{st} reTx and sends a NACK 225. Since the time before the next SMTC window is larger than a threshold (i.e., X>threshold), both the network and the UE knows that the next SMTC window is not skipped. As shown in step 225 of FIG. 2 the UE 10 sends towards the NW 1 a UL transmission of HARQ NACK. As shown in step 230 of FIG. 2 the NW 1 sends towards the UE 10 a 3^{rd} DL data transmission attempt (2^{nd} reTx). As shown in step 235 of FIG. 2 the UE 10 sends towards the NW 1 a UL transmission on HARQ ACK. However, there is enough time for the UE to send the NACK (225) the network to schedule the 2^{nd} reTx attempt that is successfully received by the UE (with CRC success). After detecting CRC success, the UE sends the ACK towards the NW. Finally after the transmission of the ACK 235, the UE will start the RRM measurements according to SMTC configuration and the network will consider the UE unavailable for scheduling. As shown in step 240 of FIG. 2 the NW 1 identifies that the UE 10 is unavailable for scheduling. Then as shown in step 245 of FIG. 2 the UE 10 identifies that it is to perform measurements in MG/SMTC window.

As shown in FIG. 2, the network and the UE decide the behavior and a configuration that is used to skip the MG/SMTC window via RRC signalling. The configuration can include parameters like the maximum time between the HARQ NACK transmission and the start of the next MG/SMTC window that triggers the skipping condition (i.e., threshold in FIG. 2), the number of MG/SMTC window(s) that can be skipped, whether to use implicit or explicit indication for skipping MG/SMTC window(s).

It is noted that an Implicit skipping can be a default behavior that is always to skip SMTC window in case of NACK. Whereas, with an Explicit (skipping) indication the UE sends towards NW its intention to skip the next SMTC window (e.g., a single bit multiplexed with the ACK/NACK feedback).

In the picture of FIG. 2, the first DL data transmission is lost, which is detected via e.g., CRC error. Then, the UE transmits a HARQ NACK. Because the time before the next MG/SMTC window X is smaller than the threshold configured via RRC signalling, the UE skips the MG/SMTC window, and the network reschedules soon the second attempt of the DL transmission. The second transmission attempt also fails, but the UE does not skip the next MG/SMTC window since it starts after the threshold configured via RRC signalling.

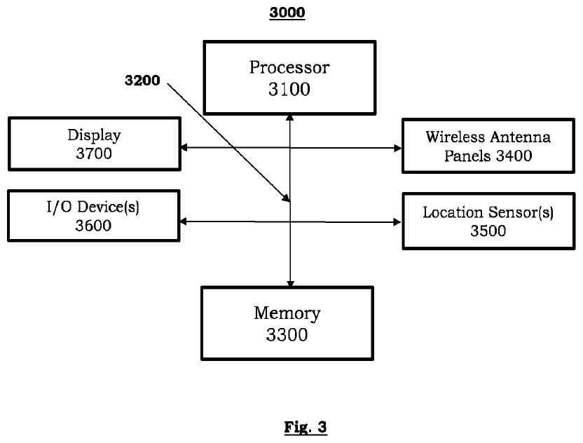

FIG. 3 shows the same example as FIG. 1 using the proposed invention.

FIG. 3 shows operations with MG/SMTC settings in accordance with the example embodiments of the invention. As shown in FIG. 3 there are 3 transmission attempts over 10 ms. One skipping of an MG/SMTC window during the 10 ms.

Since the UE is allowed to skip MG/SMTC window, it will still be available for scheduling. Therefore, the network can schedule the reTx of the UE soon after the reception of the HARQ NACK and deliver the packet within the PDB.

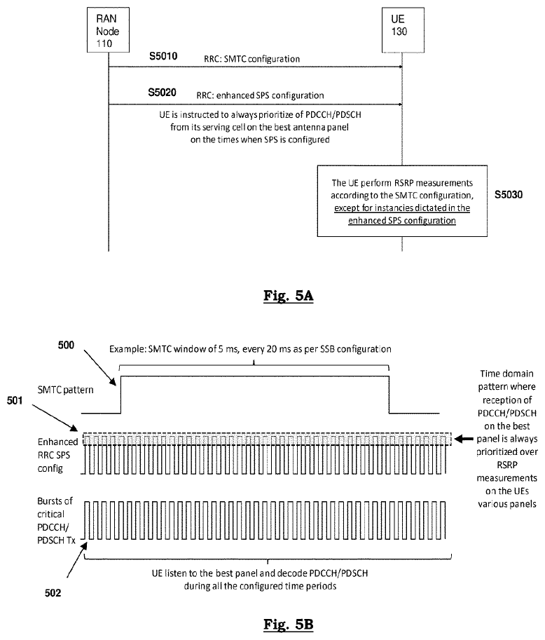

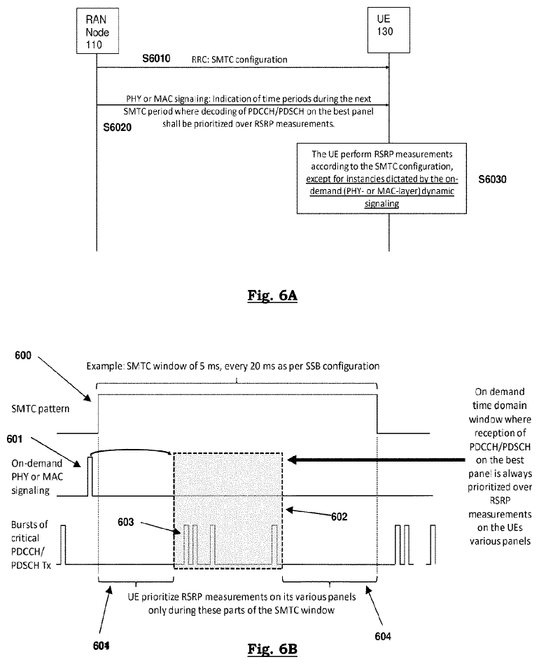

FIG. 5A and FIG. 5B each show a method in accordance with example embodiments of the invention which may be performed by an apparatus.

FIG. 5A illustrates operations which may be performed by a network device such as, but not limited to, a network device or a UE 10 as in FIG. 4 or a user equipment. As shown in step 510 of FIG. 5A there is attempting to decode a data transmission of a network node of a communication network. As shown in step 520 of FIG. 5A there is, based on the decoding failing, perform: transmitting a negative acknowledgment within a first time window, skipping a second time window for radio resource management measurements to perform transmission of the negative acknowledgment or reception of a grant scheduling a retransmission of said data transmission, or reception of a retransmission of said data transmission.

In accordance with the example embodiments as described in the paragraph above, wherein the first time window and the second time window is one of overlapping or the first time window comprises the second time window.

In accordance with the example embodiments as described in the paragraphs above, wherein the second time window comprises a measurement gap or a synchronization signal block based measurement timing configuration.

In accordance with the example embodiments as described in the paragraphs above, wherein there is sending towards the network node of the communication network information comprising an indication that the second time window comprising a measurement gap or a synchronization signal block based measurement timing configuration is to be skipped for radio resource management measurements.

In accordance with the example embodiments as described in the paragraphs above, wherein the indication that the second time window is to be skipped is one of multiplexed with a hybrid automatic repeat request negative acknowledgement or sent as a standalone indication.

In accordance with the example embodiments as described in the paragraphs above, wherein the indication that the second time window is to be skipped for radio resource management measurements comprises a transmission of a hybrid automatic repeat request negative acknowledgement within a first time window.

In accordance with the example embodiments as described in the paragraphs above, wherein the skipping is based on a mobility state and a scaling factor used for radio resource measurement relaxation.

In accordance with the example embodiments as described in the paragraphs above, wherein the indication is using a single bit.

In accordance with the example embodiments as described in the paragraphs above, wherein the indication comprises a physical uplink shared channel transmission or a physical uplink control channel transmission.

In accordance with the example embodiments as described in the paragraphs above, wherein skip measurements in a measurement gap or synchronization signal block based measurement timing configuration to prioritize transmission of the negative acknowledgement.

In accordance with the example embodiments as described in the paragraphs above, wherein there is receiving a configuration indicating to skip radio resource management measurements in the second time window in order to transmit a negative acknowledgement within the first time window or the second time window, or receiving a retransmission of the data transmission from the network node to the user equipment within the second time window.

In accordance with the example embodiments as described in the paragraphs above, wherein the data transmission comprises a hybrid automatic repeat request re-transmission.

In accordance with the example embodiments as described in the paragraphs above, wherein an indication of the at least one time window is received in the information from the network node using radio resource control signalling.

In accordance with the example embodiments as described in the paragraphs above, wherein the data transmission comprises a physical downlink shared channel transmission or physical downlink control channel transmission.

In accordance with the example embodiments as described in the paragraphs above, wherein the decoding failing is determined using a cyclic redundancy check.

In accordance with the example embodiments as described in the paragraphs above, wherein the configuration comprises the start of the first time window with respect to the second time window.

In accordance with the example embodiments as described in the paragraphs above, wherein the configuration comprises a number of occurrences of the second time window in which radio resource management measurements are to be skipped, and whether to use implicit or explicit indication for skipping the time window.

In accordance with the example embodiments as described in the paragraphs above, wherein the configuration comprises a radio resource control configuration.

In accordance with the example embodiments as described in the paragraphs above, wherein skipping the second time window for radio resource management measurements is based on a priority of an uplink negative acknowledgement, a downlink transmission or re-transmission grant from the communication network, a downlink data transmission or re-transmission from the communication network, or an uplink acknowledgement or negative acknowledgement from user equipment.

A non-transitory computer-readable medium (MEM 10B as in FIG. 4) storing program code (PROG 10C as in FIG. 4), the program code executed by at least one processor (DP 10A as in FIG. 4) to perform the operations as at least described in the paragraphs above.

In accordance with an example embodiment of the invention as described above there is an apparatus comprising: means for attempting (one or more transceivers 10D; MEM 10B; PROG 10C; and DP 10A as in FIG. 4) to decode a data transmission of a network node of a communication network; means, based on the decoding failing, performing (one or more transceivers 10D; MEM 10B; PROG 10C; and DP 10A as in FIG. 4) transmitting a negative acknowledgment within a first time window, skipping a second time window for radio resource management measurements to perform transmission of the negative acknowledgment or reception of a grant scheduling a retransmission of said data transmission, or reception of a retransmission of said data transmission.

In the example aspect of the invention according to the paragraph above, wherein at least the means for attempting, skipping, or performing comprises a non-transitory computer readable medium [MEM 10B as in FIG. 4] encoded with a computer program [PROG 10C as in FIG. 4] executable by at least one processor [DP 10A as in FIG. 4].

FIG. 5B illustrates operations which may be performed by a device such as, but not limited to, a network node (e.g., the NN 12 as in FIG. 4) or an eNB or gNB. As shown in step 550 of FIG. 5B there is sending a data transmission from a network node of a communication network towards user equipment. Then as shown in step 560 of FIG. 5B there is, based on decoding of the data transmission failing at the user equipment, receive an indication that the user equipment is to skip a second time window for radio resource management measurements for transmission of the negative acknowledgment, reception of a grant scheduling a retransmission of said data transmission, or reception of a retransmission of said data transmission, wherein the indication can be receiving a negative acknowledgment within a first time window.

In accordance with the example embodiments as described in the paragraph above, wherein the first time window and the second time window is one of overlapping or the first time window comprises the second time window.

In accordance with the example embodiments as described in the paragraphs above, wherein the second time window comprises a measurement gap or a synchronization signal block based measurement timing configuration.

In accordance with the example embodiments as described in the paragraphs above, wherein the indication is that the second time window comprising a synchronization signal block based measurement timing configuration window is to be skipped for radio resource management measurements.

In accordance with the example embodiments as described in the paragraphs above, wherein the indication that the second time window is to be skipped is one of multiplexed with a hybrid automatic repeat request negative acknowledgement or sent as a standalone indication, and wherein the indication that the second time window is to be skipped for radio resource management measurements comprises a reception of a hybrid automatic repeat request negative acknowledgement within a first time window.

In accordance with the example embodiments as described in the paragraphs above, wherein the skipping is based on a mobility state and a scaling factor used for radio resource measurement relaxation.

In accordance with the example embodiments as described in the paragraphs above, wherein the indication is using a single bit.

In accordance with the example embodiments as described in the paragraphs above, wherein the indication comprises a physical uplink shared channel transmission or a physical uplink control channel transmission.

In accordance with the example embodiments as described in the paragraphs above, wherein the indication is that the user equipment will skip measurements in a measurement gap or synchronization signal block based measurement timing configuration to prioritize transmission of the negative acknowledgement.

In accordance with the example embodiments as described in the paragraphs above, wherein there is sending a configuration indicating to the user equipment to skip radio resource management measurements in the second time window in order to transmit or receive a negative acknowledgement from the user equipment within the first time window or the second time window, or sending a retransmission of the data transmission from the network node to the user equipment within the second time window.

In accordance with the example embodiments as described in the paragraphs above, wherein the data transmission comprises a hybrid automatic repeat request re-transmission.

In accordance with the example embodiments as described in the paragraphs above, wherein the data transmission comprises a physical downlink shared channel transmission or physical downlink control channel transmission.

In accordance with the example embodiments as described in the paragraphs above, wherein the configuration comprises a start of the first time window with respect to the second time window.

In accordance with the example embodiments as described in the paragraphs above, wherein the configuration comprises a number of occurrences of the second time window in which radio resource management measurements are to be skipped, and whether to use implicit or explicit indication for skipping the time window.

A non-transitory computer-readable medium (MEM 12B and/or MEM 13B as in FIG. 4) storing program code (PROG 12C and/or PROG 13C as in FIG. 4), the program code executed by at least one processor (DP 12A and/or DP 13A as in FIG. 4) to perform the operations as at least described in the paragraphs above.

In accordance with an example embodiment of the invention as described above there is an apparatus comprising: means for sending (one or more transceivers 12D and/or 13D; MEM 12B and/or MEM 13B; PROG 12C and/or PROG 13C); and DP 12A and/or DP 13A as in FIG. 4) a data transmission from a network node (NN 12 and/or NN 13 as in FIG. 4) of a communication network (Network 1 as in FIG. 4) towards user equipment (UE 10 as in FIG. 4; and means, based on decoding of the data transmission failing at the user equipment, for receiving (one or more transceivers 12D and/or 13D; MEM 12B and/or MEM 13B; PROG 12C and/or PROG 13C); and DP 12A and/or DP 13A as in FIG. 4) an indication that the user equipment is to skip a second time window for radio resource management measurements for transmission of the negative acknowledgment, reception of a grant scheduling a retransmission of said data transmission, or reception of a retransmission of said data transmission, wherein the indication can be receiving a negative acknowledgment within a first time window.

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
(i) a combination of analog and/or digital hardware circuit(s) with software/firmware; and
(ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the invention, there is adequate circuitry for performing at least novel operations in accordance with example embodiments of the invention as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of example embodiments of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1-34. (canceled)

35. An apparatus, comprising:
at least one processor; and
at least one non-transitory memory storing instructions, that when executed by the at least one processor, cause the apparatus at least to:
attempt to decode a data transmission of a network node of a communication network;
based on the decoding failing, perform:
transmitting a negative acknowledgment within a first time window,
skipping a second time window for radio resource management measurements to perform transmission of the negative acknowledgment or reception of a grant scheduling a retransmission of said data transmission or reception of a retransmission of said data transmission.

36. The apparatus of claim 35, wherein the first time window and the second time window is one of overlapping or the first time window comprises the second time window.

37. The apparatus of claim 35, wherein the second time window comprises a measurement gap or a synchronization signal block based measurement timing configuration.

38. The apparatus of claim 37, wherein the at least one non-transitory memory is storing instructions executed by the at least one processor to cause the apparatus to:
send towards the network node of the communication network information comprising an indication that the second time window comprising a measurement gap or a synchronization signal block based measurement timing configuration is to be skipped for radio resource management measurements.

39. The apparatus of claim 38, wherein the indication that the second time window is to be skipped is one of multiplexed with a hybrid automatic repeat request negative acknowledgement or sent as a standalone indication, and
wherein the indication that the second time window is to be skipped for radio resource management measurements comprises a transmission of a hybrid automatic repeat request negative acknowledgement within a first time window.

40. The apparatus of claim 38, wherein the skipping is based on a mobility state and a scaling factor used for radio resource measurement relaxation.

41. The apparatus of claim 38, wherein the indication is using a single bit.

42. The apparatus of claim 38, wherein the indication comprises a physical uplink shared channel transmission or a physical uplink control channel transmission.

43. The apparatus of claim 35, wherein the at least one non-transitory memory is storing instructions executed by the at least one processor to cause the apparatus to:
skip measurements in a measurement gap or synchronization signal block based measurement timing configuration to prioritize transmission of the negative acknowledgement.

44. The apparatus of claim 43, wherein the at least one non-transitory memory is storing instructions executed by the at least one processor to cause the apparatus to:
receive a configuration indicating to skip radio resource management measurements in the second time window in order to transmit a negative acknowledgement within the first time window or the second time window, or receive a retransmission of the data transmission from the network node to the user equipment within the second time window.

45. The apparatus of claim 35, wherein the data transmission comprises a hybrid automatic repeat request re-transmission.

46. The apparatus of claim 35, wherein an indication of the at least one time window is received in the information from the network node using radio resource control signalling.

47. The apparatus of claim 35, wherein the data transmission comprises a physical downlink shared channel transmission or physical downlink control channel transmission.

48. The apparatus of claim 35, wherein the decoding failing is determined using a cyclic redundancy check.

49. The apparatus of claim 44, wherein the configuration comprises the start of the first time window with respect to the second time window.

50. The apparatus of claim 44, wherein the configuration comprises a number of occurrences of the second time window in which radio resource management measurements are to be skipped, and whether to use implicit or explicit indication for skipping the time window.

51. The apparatus of claim 44, wherein the configuration comprises a radio resource control configuration.

52. The apparatus of claim 44, wherein skipping the second time window for radio resource management measurements is based on a priority of an uplink negative acknowledgement, a downlink transmission or re-transmission grant from the communication network, a downlink data transmission or re-transmission from the communication network, or an uplink acknowledgement or negative acknowledgement from user equipment.

53. A method, comprising:
attempting to decode a data transmission of a network node of a communication network;
based on the decoding failing, performing:
transmitting a negative acknowledgment within a first time window, skip a second time window for radio resource management measurements to perform transmission of the negative acknowledgment, or reception of a grant scheduling a retransmission of said data transmission, or reception of a retransmission of said data transmission.

54. An apparatus, comprising:
at least one processor; and
at least one non-transitory memory storing instructions, that when executed by the at least one processor, cause the apparatus at least to:
send a data transmission from a network node of a communication network towards a user equipment;
based on decoding of the data transmission failing at the user equipment, receive an indication that the user equipment is to skip a second time window for radio resource management measurements to perform transmission of the negative acknowledgment, reception of a grant scheduling a reception, or retransmission of said data transmission, or reception of a retransmission of said data transmission,
wherein the indication can be receiving a negative acknowledgment within a first time window.
